(19) United States
(12) Patent Application Publication
(10) Pub. No.: US 2005/0237404 A1
(43) Pub. Date: Oct. 27, 2005

(54) Jfet charge control device for an imager pixel

(76) Inventors: Dmitri Jerdev, South Pasadena, CA (US); Gennadiy A. Agranov, Sunland, CA (US)

Correspondence Address: DICKSTEIN SHAPIRO MORIN & OSHINSKY LLP, 2101 L Street, NW, Washington, DC, 20037, US

(21) Appl. No.: 10/832,373

(22) Filed: Apr. 27, 2004

(51) Int. Cl. H04N 3/14

(52) U.S. Cl. 348/303; 348/302

(57) ABSTRACT

A pixel cell that utilizes a JFET transistor, instead of a CMOS transistor, linked to each pixel's photosensor as an anti-blooming and/or transfer transistor to provide an overflow path for electrons during charge integration. Using a JFET transistor reduces charge uncertainty and fixed pattern noise in the imaging system.

### FIELD OF THE INVENTION

The invention relates to imager devices generally and particularly to improving the control and operation of an imager pixel.

### BACKGROUND OF THE INVENTION

An imager, for example, a CMOS imager includes a focal plane array of pixel cells; each cell includes a photosensor, for example, a photogate, photoconductor or a photodiode overlying a substrate for producing a photo-generated charge in a doped region of the substrate. A pixel uses CMOS transistors, which are a form of metal oxide semiconductor field effect transistor (MOSFET). A readout circuit is provided for each pixel cell and typically includes at least a source follower transistor and a row select transistor for coupling the source follower transistor to a column output line. The pixel cell also typically has a charge storage node, for example, a floating diffusion region which is, in turn, connected to the gate of the source follower transistor. Charge generated by the photosensor is stored at the storage node. In some arrangements, the imager may also include a transistor for transferring charge from the photosensor to the storage node. The imager also typically includes a transistor to reset the storage node before it receives photo-generated charges.

FIG. 1 illustrates a block diagram of a CMOS imager device 908 having a pixel array 200 with each pixel cell being constructed as described above, or as other known pixel cell circuits. Pixel array 200 comprises a plurality of pixels arranged in a predetermined number of columns and rows (not shown). The pixels of a row in array 200 are all turned on at the same time by a row selected line, and the pixels of each column are selectively output by respective column select lines. A plurality of row and column lines are provided for the entire array 200. The row lines are selectively activated in sequence by the row driver 210 in response to row address decoder 220. The column select lines are selectively activated in sequence for each row activation by the column driver 260 in response to column address decoder 270. Thus, a row and column address is provided for each pixel.

The CMOS imager is operated by control circuit 250, which controls address decoders 220, 270 for selecting the appropriate row and column lines for pixel readout, and row and column driver circuitry 210, 260 that apply driving voltage to the drive transistors of the selected row and column lines. The pixel output signals typically include a pixel reset signal Vᵣₛₜ taken off of the floating diffusion region when it is reset by reset transistor and a pixel image signal V_{sig}, which is taken off the floating diffusion region after photo-generated charges are transferred to it. The Vᵣₛₜ and V_{sig} signals are read by a sample and hold circuit 265 and are subtracted by a differential amplifier 267, to produce a signal Vᵣₛₜ−V_{sig} for each pixel that represents the amount of light impinging on the pixels. This difference signal is digitized by an analog-to-digital converter 275. The digitized pixel signals are fed to an image processor 280 to form a digital image. The digitizing and image processing can be located on or off the imager chip. In some arrangements the differential signal Vᵣₛₜ−V_{sig} is amplified as a differential signal and directly digitized by a differential analog to digital converter.

In a CMOS imager pixel cell, for example, a five transistor (5T) pixel cell 100 depicted in FIG. 2, the active elements of the cell perform the functions of (1) photon to charge conversion by a photodiode 102; (2) transfer of excess charge from the photodiode 102 by an anti-blooming transistor 112 when the photodiode 102 is overexposed during photon to charge conversion and becomes saturated during a charge integration period; (3) resetting the floating diffusion region 106 to a known state by the reset transistor 108 before charge transfer from photodiode 102 to the floating diffusion region 106; (4) transfer of charge from the photodiode 102 to the floating diffusion region 106 by the transfer transistor 104 after the charge integration period; (5) selection of a pixel cell for readout by a row select transistor 114; and (6) output and amplification of signals representing charge on floating diffusion region 106 by the source follower transistor 110 as a reset voltage after reset and as a pixel signal voltage based on the photo-converted charges after charge transfer. The pixel 100 of FIG. 2 is formed on a semiconductor substrate as part of an imager device pixel array, e.g. array 200 of FIG. 1.

When anti-blooming transistor 112 is turned on by an anti-blooming control signal AB to drain excess charge from the photodiode 102 during the integration period, a high charge barrier AB created by the anti-blooming transistor 112 (FIG. 3A) is present between the photodiode 102 and charge sink voltage V_{AB}. This barrier AB must be overcome when the photodiode 102 approaches saturation, before excess charges are drained to V_{AB} through anti-blooming transistor 112.

Typically, a charge transfer CMOS transistor 104 is utilized in a pixel cell to create a charge transfer barrier between the floating diffusion region 106 and a CMOS anti-blooming transistor is utilized to create a charge barrier between the photodiode 102 and a discharging point. Controlling these barriers when operating the pixel cells in a high dynamic mode (HiDy), is achieved by applying a variable potential to gates of the anti-blooming transistor 112 or transfer transistor 104. Controlling the anti-blooming transistor 112 and transfer transistor 104 in such a manner controls the maximum charge accumulated in the pixel cells at any given time during charge integration.

However, there is a problem in using CMOS transistors as barriers in imager pixel cells. CMOS transistors have a high deviation in threshold voltage Vₜₕ from wafer to wafer, and often from transistor to transistor. The deviation is created to a large extent by the gate oxide layer. For example, the gate oxide layer can assimilate floating charges that make it difficult to precisely control the transistors. This deviation leads to an uncertainty in the amount of charge stored from pixel cell to pixel cell since the threshold voltage Vₜₕ of each transistor could vary. The variance of charge storage from pixel cell to pixel cell in an imager array leads to fixed pattern noise (FPN) resulting in diminished image quality because non-uniformity of barrier heights between pixels.

FIGS. 3A and 3B illustrate the charge uncertainty that could occur from pixel cell to pixel cell due to the high deviation of threshold voltage among anti-blooming transistors of pixel array 200. The pixel depicted in FIG. 3A illustrates an ideal situation in which there is no variation in threshold voltage Vₜₕ between anti-blooming transistors. Since there is no variation in threshold voltage Vₜₕ, each pixel acquires the same amount of charge, during image acquisition, before the respective anti-blooming transistors are turned on. However, the situation depicted in FIG. 3B illustrates actual pixels utilizing CMOS anti-blooming transistors during image acquisition. Because there are threshold voltage Vₜₕ variations between anti-blooming transistors in the imager array, barrier heights created by each anti-blooming transistor are not uniform and generally fall in the range 150 illustrated in FIG. 3B. Consequently, the fixed pattern noise for the imager array increases resulting in diminished image quality.

FIG. 4 graphically illustrates the signal non-uniformity between pixel cells due to deviations in Vₜₕ when utilizing a CMOS transistor as an anti-blooming transistor. Using CMOS transistors as anti-blooming transistors could result in as much as a 0.1 volt output signal variation from pixel cell to pixel cell. A similar problem exist the gate of the transfer transistor as with the CMOS anti-blooming transistor.

Accordingly, there is a need and desire for an imager with improved anti-blooming and/or charge transfer control.

### BRIEF SUMMARY OF THE INVENTION

Various embodiments of the invention provide a new pixel design for an imager in which a junction field effect transistor (JFET) transistor is provided in an anti-blooming path during charge integration. Since a JFET transistor does not have an oxide layer below its gate, it has a better defined threshold voltage (Vₜₕ) and thus it provides improved charge control for the pixel. Utilizing a JFET transistor as an anti-blooming transistor thus reduces pixel-to-pixel charge uncertainty. The reduction of fixed pattern noise results in improved image quality.

Some embodiments employ a JFET transistor in the charge transfer path of a pixel.

Still other embodiments employ a JFET transistor both in the anti-blooming path and in the charge transfer path of a pixel.

### BRIEF DESCRIPTION OF THE DRAWINGS

These and other features and advantages of the invention will be better understood from the following detailed description, which is provided in connection with the accompanying drawings, in which:

FIG. 1 is a block diagram of a conventional imager device;

FIG. 2 is a schematic diagram of a conventional five transistor pixel;

FIG. 3 is a voltage threshold diagram comparing a conventional five transistor pixel and an ideal pixel;

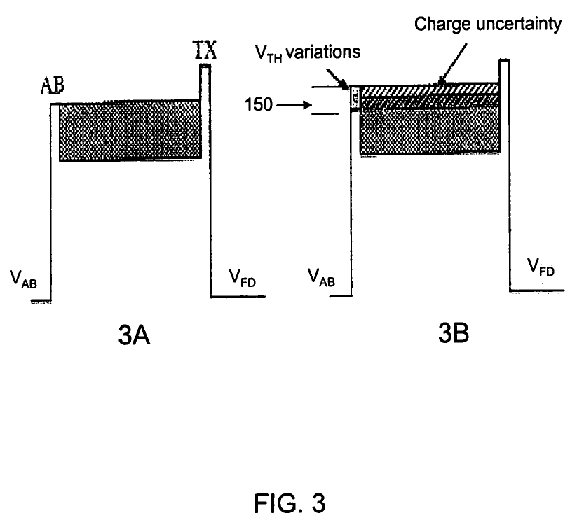

FIG. 4 is a graph of fixed pattern noise due to threshold voltage variations between conventional five transistor pixels operating in a high dynamic range mode;

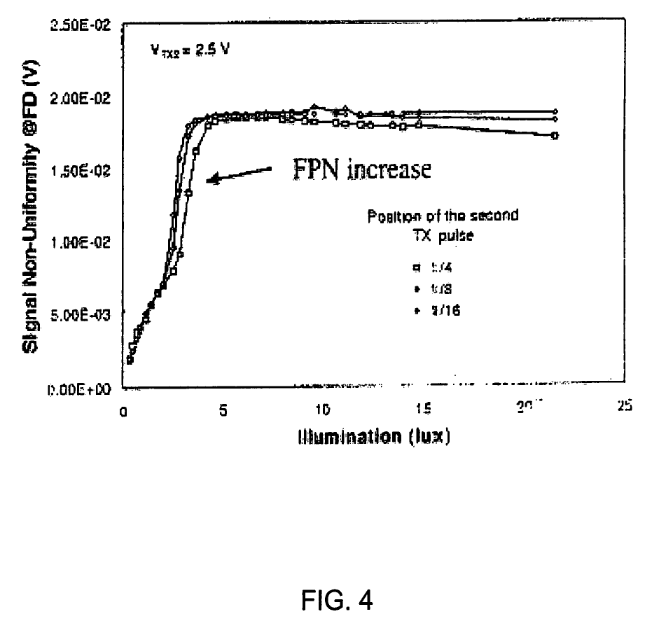

FIG. 5 is a schematic circuit diagram according to a first embodiment of the invention;

FIG. 6 is a schematic circuit diagram according to a second embodiment of the invention;

FIG. 7 is a schematic circuit diagram according to a third embodiment of the invention; and

FIG. 8 is a diagram of a processing system which employs an imager employing an array of pixels constructed in accordance with the various embodiments of the invention.

### DETAILED DESCRIPTION OF THE INVENTION

In the following detailed description, reference is made to the accompanying drawings, which are a part of the specification, and in which is shown by way of illustration various embodiments whereby the invention may be practiced. These embodiments are described in sufficient detail to enable those skilled in the art to make and use the invention. It is to be understood that other embodiments may be utilized, and that structural, logical, and electrical changes, as well as changes in the materials used, may be made without departing from the spirit and scope of the present invention. Additionally, certain processing steps are described and a particular order of processing steps is disclosed; however, the sequence of steps is not limited to that set forth herein and may be changed as is known in the art, with the exception of steps or acts necessarily occurring in a certain order.

The terms “wafer” and “substrate” are to be understood as interchangeable and as including silicon, silicon-on-insulator (SOI) or silicon-on-sapphire (SOS), doped and undoped semiconductors, epitaxial layers of silicon supported by a base semiconductor foundation, and other semiconductor structures. Furthermore, when reference is made to a “wafer” or “substrate” in the following description, previous process steps may have been utilized to form regions, junctions or material layers in or on the base semiconductor structure or foundation. In addition, the semiconductor need not be silicon-based, but could be based on silicon-germanium, germanium, gallium arsenide, or other known semiconductor materials.

The term “pixel” refers to a photo-element unit cell containing a photo-conversion device or photosensor, for example, a photogate, photoconductor or a photodiode and transistors for processing an electrical signal from electromagnetic radiation sensed by the photo-conversion device. The embodiments of pixels discussed herein are illustrated and described as employing five transistor (5T) pixel circuits for the sake of example only. It should be understood that the invention may be used with other pixel arrangements having more or less than five transistors.

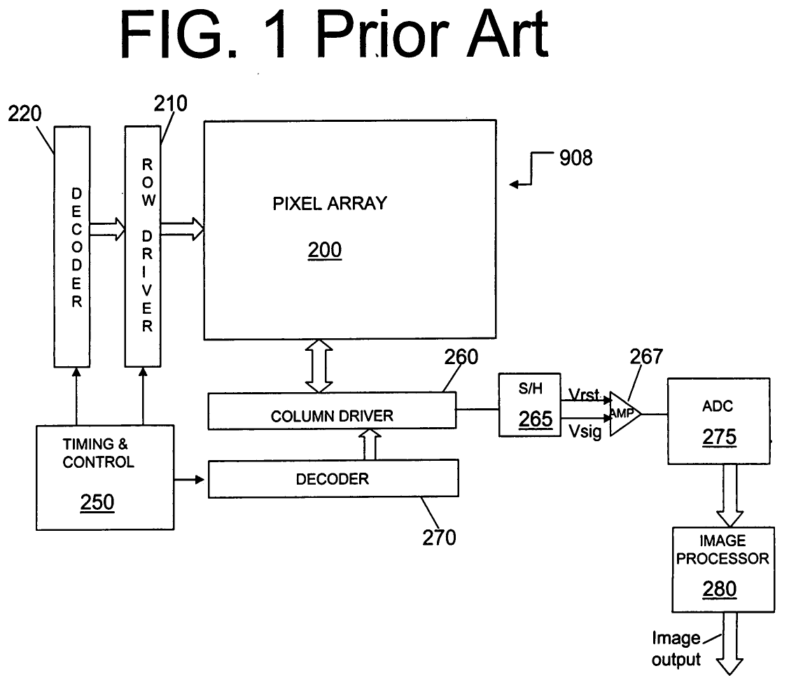

Although the invention is described herein with reference to the architecture and fabrication of one pixel cell, it should be understood that this is representative of a plurality of pixels in an array of an imager device such as array 200 of imager device 908 (FIG. 1). In addition, although the invention is described below with reference to a CMOS imager, the invention has applicability to any solid state imaging device having pixels. The following detailed description is, therefore, not to be taken in a limiting sense, and the scope of the present invention is defined only by the appended claims.

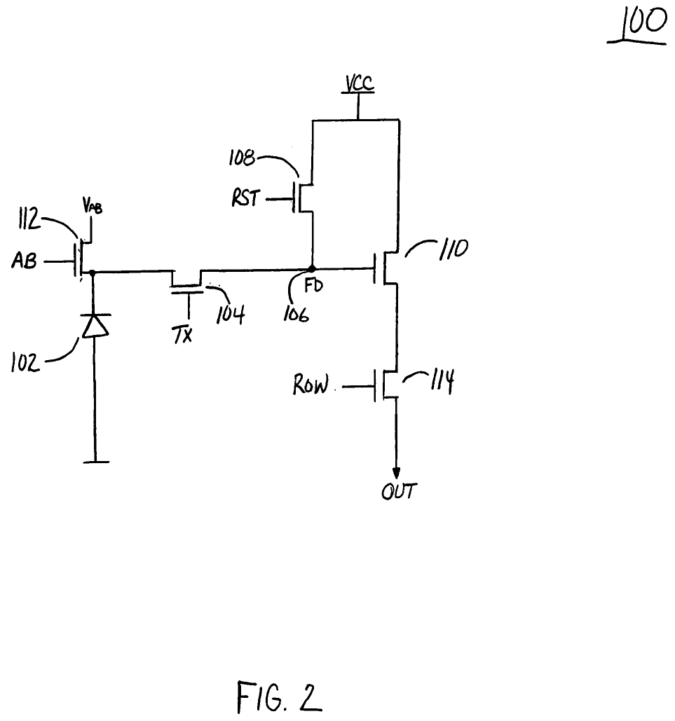

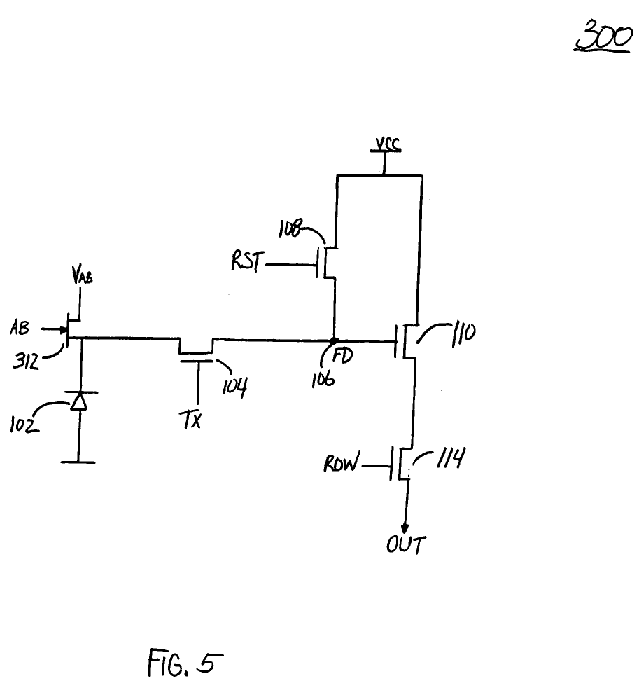

FIG. 5 illustrates a pixel circuit 300 according to a first exemplary embodiment of the invention. Pixel circuit 300 is similar to pixel circuit 100 (FIG. 2) as indicated by common designations; however, a JFET anti-blooming transistor 312 is employed between photodiode 102 and a charge sink voltage (V_{AB}). Since the JFET transistor 312 does not have pixel-to-pixel threshold variations caused by the presence of the gate oxide layer in a CMOS transistor, the pixel 300 experiences more consistent pixel-to-pixel anti-blooming control and reduced fixed pattern noise.

Control of anti-blooming transistor 312 is accomplished by applying a control voltage to the transistor gate. Unlike CMOS transistors, the voltage threshold of the anti-blooming transistor 312 is determined by the doping levels in the channel and gate areas of the transistor 312. The gate of anti-blooming transistor 312 represents a p-doped region, for example, electrically isolated from a p-region around photodiode 102. Consequently, the gate potential of anti-blooming transistor 312 may be changed independently from the p-region around photodiode 102 and the gate threshold voltage is unaffected by changes in an underlying oxide layer.

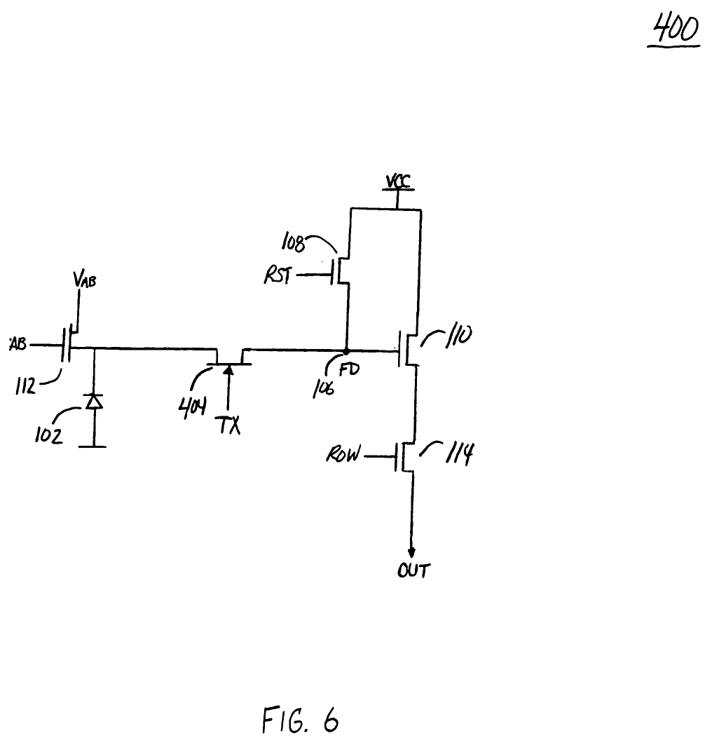

FIG. 6 illustrates a pixel circuit 400 according to another embodiment of the invention. In the illustrated embodiment, a CMOS anti-blooming transistor 112 is used, but the transfer transistor 404 utilizes a JFET instead of a CMOS transistor. Using a JFET as a transfer transistor improves image quality when operating in a high dynamic range mode since there is a similar problem with threshold voltage deviation at the gate of a CMOS transfer transistor as with the CMOS anti-blooming transistor.

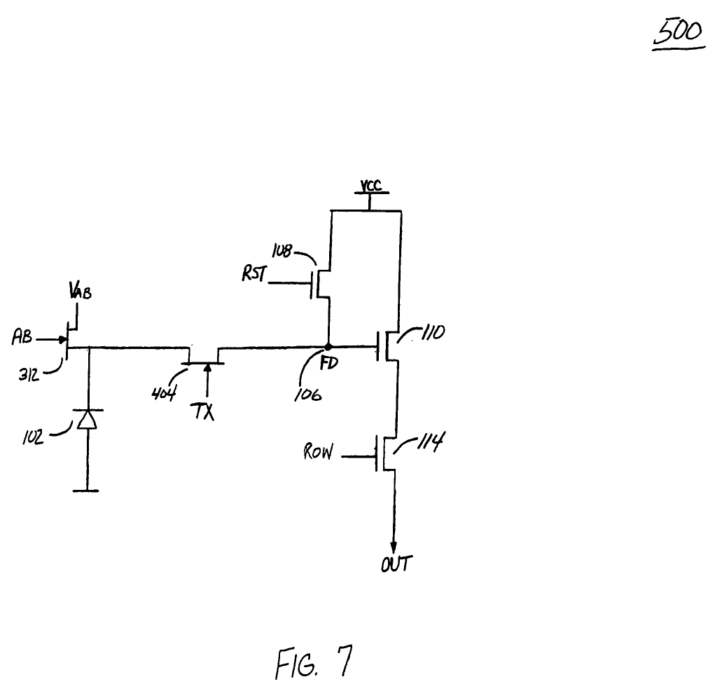

FIG. 7 illustrates a pixel circuit 500 according to another embodiment of the invention. In the illustrated embodiment, transfer transistor 404 and anti-blooming transistor 312 are JFETs. By using a JFET as an anti-blooming transistor 312 and a transfer transistor 404 the image quality of the imager array is further improved.

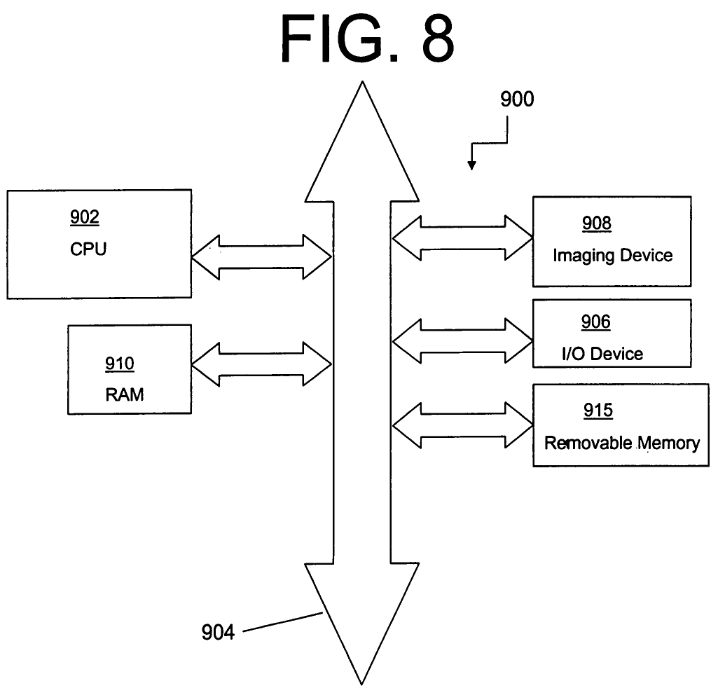

FIG. 8 illustrates a processor-based system 900 including an imaging device 908 of FIG. 1. The processor-based system 900 is exemplary of a system having digital circuits that could include image sensor devices. Without being limiting, such a system could include a computer system, camera system, scanner, machine vision, vehicle navigation, video phone, surveillance system, auto focus system, star tracker system, motion detection system, image stabilization system, and data compression system.

The processor-based system 900, for example a camera system, generally comprises a central processing unit (CPU) 902, such as a microprocessor, that communicates with an input/output (I/O) device 906 over a bus 904. Imaging device 908 also communicates with the CPU 902 over bus 904. The processor-based system 900 also includes random access memory (RAM) 910, and can include removable memory 915, such as flash memory, which also communicate with CPU 902 over the bus 904. Imaging device 908 may be combined with a processor, such as a CPU, digital signal processor, or microprocessor, with or without memory storage on a single integrated circuit or on a different chip than the processor.

Various embodiments of the invention have been illustrated using a photodiode as the charge conversion device, and in the environment of a five transistor pixel. However, it should be appreciated that the invention is not so limited and can be used in any pixel architecture employing one or both of an anti-blooming transistor and charge transfer transistor, and any other transistor where there may be pixel-to-pixel or wafer-to-wafer variations in pixel signal output due to variations in gate trapped charges when a CMOS transistor is employed. Also, other types of photosensors may be used to generate image charge. Accordingly, it is not intended that the present invention be strictly limited to the above-described and illustrated embodiment. Any modifications, though presently unforeseeable, of the present invention that comes within the spirit and scope of the following claims should be considered part of the present invention.

1. A pixel circuit for an imaging device, said pixel circuit comprising:
a photosensor for generating charge during an integration period;
a storage node for receiving said generated charge from said photosensor; and
a JFET transistor connected to said photosensor for providing an over flow path for charge generated during said integration period.

2. The circuit of claim 1 further comprising a readout circuit for reading out stored charge from said storage node and providing an output signal based said charge at the storage node.

3. The circuit of claim 1 further comprising a transfer transistor connected to said photosensor to transfer charge from said photosensor to said storage node.

4. The circuit of claim 3, wherein said transfer transistor is a JFET transistor.

5. A pixel circuit for an imaging device, said pixel circuit comprising:
a photosensor for generating charge during an integration period;
a storage node for receiving said generated charge from said photosensor;
an anti-blooming transistor connected to said photosensor for providing an over flow path for charge generated during said integration period; and
a JFET transistor connected to said photosensor to transfer charge from said photosensor to said storage node.

6. The circuit of claim 5 further comprising a readout circuit for reading out stored charge from said storage node and providing an output signal based said charge at the storage node.

7. A pixel circuit for an imaging device, said pixel circuit comprising:
a photosensor for generating charge during an integration period;
a storage node for receiving said generated charge from said photosensor;
a JFET transistor connected to said photosensor for providing an over flow path for charge generated during said integration period;
a reset transistor connected to said storage node for applying a reset voltage to said storage node;
a source-follower transistor having a gate connected to said storage node for providing a signal based on stored at the storage node; and
a row select transistor connected to said source-follower transistor for outputting a signal produced by said source follower transistor.

8. The circuit of claim 7 further comprising a transfer transistor connected to said photosensor to transfer charge from said photosensor to said storage node.

9. The circuit of claim 8, wherein said transfer transistor is a JFET transistor.

10. An integrated circuit comprising:
a plurality of pixels, each pixel comprising:
a photosensor for generating charge during an integration period;
a storage node for receiving said generated charge from said photosensor; and
a JFET transistor connected to said photosensor for providing an over flow path for charge generated during said integration period.

11. The circuit of claim 10 further comprising a readout circuit for reading out stored charge from said storage node and providing an output signal based said charge at the storage node.

12. The circuit of claim 10 further comprising a transfer transistor connected to said photosensor to transfer charge from said photosensor to said storage node.

13. The circuit of claim 12, wherein said transfer transistor is a JFET transistor.

14. An imaging system comprising:
a processor; and
an imaging device comprising an array of pixels coupled to said processor, each pixel including:
a photosensor for generating charge during an integration period;
a storage node for receiving said generated charge from said photosensor; and
a JFET transistor connected to said photosensor for providing an over flow path for charge generated during said integration period.

15. The system of claim 14 further comprising a readout circuit for reading out stored charge from said storage node and providing an output signal based said charge at the storage node.

16. The system of claim 14 further comprising a transfer transistor connected to said photosensor to transfer charge from said photosensor to said storage node.

17. The system of claim 16, wherein said transfer transistor is a JFET transistor.

18. An imaging system comprising:
a processor; and
an imaging device comprising an array of pixels coupled to said processor, each pixel including:
a photosensor for generating charge during an integration period;
a storage node for receiving said generated charge from said photosensor;
an anti-blooming transistor connected to said photosensor for providing an over flow path for electrons during said integration period; and
a JFET transistor connected to said photosensor to transfer charge from said photosensor to said storage node.

19. The system of claim 18 further comprising a readout circuit for reading out stored charge from said storage node and providing an output signal based said charge at the storage node.

20. A method of operating a pixel of an image sensor comprising:
controlling the amount of charge accumulated in a photosensor using a junction field effect transistor (JFET);
transferring charge from the photosensor to a storage node; and
outputting an output signal on an output line based on the charge at said storage node.

21. The method of claim 20 further comprising applying a bias voltage to a gate of said JFET transistor to control a barrier potential for overflow charge from said photosensor.

22. The method of claim 20, wherein said JFET transistor transports overflow charge from said photosensor.

23. The method of claim 20, wherein said transferring uses a JFET transistor to transfer charge to said storage node.

24. A pixel circuit comprising:
a photosensor for generating charge during an integration period; and
a transistor circuit for converting said charge to a pixel output signal, at least one transistor of said transistor circuit being a JFET transistor.

25. The circuit of claim 24, wherein at one other transistor of said transistor circuit is a MOSFET transistor.

26. A method of operating a pixel of an image sensor comprising:
generating charge in a photosensor during an integration period
converting said charge to a pixel output signal; and
outputting said pixel output signal onto an output line, wherein said pixel operation uses at least one JFET transistor to output said output signal.

27. The method of claim 26, wherein said pixel operation uses at least one MOSFET transistor to output said output signal.
